(19) United States
(12) Patent Application Publication
(10) Pub. No.: US 2025/0179304 A1
(43) Pub. Date: Jun. 5, 2025

(54) MODIFICATION OF COMMERCIAL CARBON BLACK GRADES VIA SURFACE MODIFICATION

(71) Applicant: Continental Carbon Co., Houston, TX (US)

(72) Inventors: Lashan M.H. DE SILVA, Dickinson, TX (US); Raymond SOUFIANI, Richmond, TX (US); Michael Brendan RODGERS, Leander, TX (US); Eduardo VEGA, Jr., Richmond, TX (US); Angel Jose MARCUCCI, Spring, TX (US)

(21) Appl. No.: 19/048,234

(22) Filed: Feb. 7, 2025

Related U.S. Application Data
(63) Continuation-in-part of application No. 18/217,317, filed on Jun. 30, 2023.
(60) Provisional application No. 63/357,991, filed on Jul. 1, 2022.
(60) Provisional application No. 63/460,242, filed on Apr. 18, 2023.

(51) Int. Cl. C09C 1/56

(52) U.S. Cl. CPC C09C 1/56; C01P 2006/12; C01P 2006/19

(57) ABSTRACT

A composition of a surface modified non-oxidized non-low hysteresis carbon blacks is disclosed. Chemical modification of low hysteresis carbon black has been demonstrated in earlier work. All of the work is constrained by the selection of specific grades of carbon black and the applicability of the technology has not been fully explored. The surface of non-low hysteresis carbon blacks including the ASTM defined carbon blacks modified with a compound comprising at least one amine group and at least one thiol group, and/or di- and/or polysulfidic linkage. This work further demonstrates the applicability of the technology to additional carbon black grades and by inference, to all grades of carbon black used in tire and industrial rubber products. Benefits are lower hysteresis with no loss in abrasion resistance.

### CROSS-REFERENCE TO RELATED APPLICATIONS

This application is a continuation-in-part of U.S. application Ser. No. 18/217,317 filed Jun. 30, 2023, and entitled “Chemically surface modified carbon black and methods of making same,” which claims the benefit of U.S. provisional patent application Ser. No. 63/357,991, filed Jul. 1, 2022 and entitled “Thermochemically Surface Modified Carbon Black to Improve Tire Rolling Resistance, Wet Traction, and Wear Resistance Comparable to Silica and Method of Making Same,” and U.S. provisional patent application Ser. No. 63/460,242, filed Apr. 18, 2023, the disclosure of each of which is hereby incorporated herein by reference in its entirety for purposes not contrary to this disclosure.

### BACKGROUND

This disclosure relates to a surface modified non-low hysteresis carbon black compound. This disclosure also relates to the surface modified ASTM defined carbon black compound.

Classification of rubber grade carbon blacks is by use of a four-character nomenclature system and has been described in the standard, ASTM D1765 titled “Standard Classification System for Carbon Blacks Used in Rubber Products”. The grades of carbon black are therefore well defined. To those familiar with carbon black types, the material will fall into one of three general classes depending on the manufacturing process, i) furnace grades, ii) thermal types, and iii) acetylene types. In addition, Austin Blacks produced from coal and all three types are described here, furnace, thermal, and acetylene, are within scope of this disclosure. All three types, furnace, thermal, and acetylene can have the same types of feedstocks, i.e., crude oil, tars, or natural gas including acetylene. In terms of global production, furnace type carbon black grades are the dominant due to the reinforcing properties in rubber compounds. Thermal grades are much less reinforcing though still find application in, for example, tires and specifically in tire inner liners. Acetylene grades which have much larger particle and aggregate sizes find use in applications where greater thermal and electrical conductivity is required. An example might be for tire curing bladder compounds where high levels of thermal conductivity is required.

Furnace grades of carbon black fall into one of seven groups depending on the particle size (Table I). These are super abrasion furnace (SAF), intermediate super abrasion furnace (ISAF), and high abrasion furnace (HAF) grades which are used, for example, in tread compounds or conveyor belt cover compounds. This is followed by fast furnace (FF), fast extrusion furnace (FEF), general purpose furnace (GPF), and semi-reinforcing furnace (SRF) grades which are used typically in tire casing compounds and other components which are parts of industrial rubber products. Grades of carbon back within each of the seven groups are also well defined as shown in Table II and further described in the industrial standard, ASTM D1765 of which rubber technologists are familiar.

The selection of any grade of carbon black for a tire component or other compound used in an industrial product will depend on the mission profile and performance envelope of the end product. For example, the carbon black grades, N110, N121, N220, and N234 are most suitable for excellent abrasion resistance and are thus used in tire tread compounds. Due to the large particle size, grades such as N660 and N762 are suitable for use in sheets or liners where low permeability is required.

TABLE I
Tire and Industrial Products Carbon Black Categories

| Group | ASTM | Particle Size | Application |
|---|---|---|---|
| | Primary | nm | |
| | Grade | | |
| SAF | N110 | 11-19 | Treads |
| ISAF | N220 | 20-25 | Treads |
| HAF | N330 | 26-30 | Tread, Casing |
| FF | N475 | 30-39 | Industrial Products |
| FEF | N550 | 40-49 | Tire casing Industrial Products |
| GPF | N660 | 50-60 | Tire casing Industrial Products |
| SRF | N762 | 60-100 | Industrial Products |

Improvement in carbon black properties and development of new grades for tires is constrained due to tire production factories capabilities, specifically the limited number of carbon black silos and towers to hold additional or new grades. Despite this, considerable effort in improving carbon black has been undertaken.

Conversely, new tire manufacturing systems such as carbon black discharge systems using super-sacks of nominally one-ton weight capacity suppling tire factory compound internal mixing systems has created opportunities for new technology carbon black materials, thus now facilitating their adaption.

Tires represent the largest usage of carbon black, with carbon black consisting of up to 50% of a given tire compound weight. After the polymer, carbon back has the largest effect on compound hysteresis, and in turn whole tire rolling resistance. Thus, changes in carbon black have been studied to reduce hysteresis, improve tire rolling resistance, and in turn improve tire-vehicle system fuel economy. One approach has been to change the carbon black particle size distribution. As an empirical guideline, the smaller the particle size as measured by increasing the Iodine number, the better the abrasion resistance but this will have a detrimental effect on compound hysteresis which, if used in a tire tread, will affect rolling resistance. Conversely, increasing the particle size as measured by decreasing the Iodine Number will improve hysteresis, decrease rolling resistance, but have an adverse effect on abrasion resistance and tire wear.

TABLE II
Common Commercial Grades of Carbon Black

| ASTM | Iodine | Oil | Compressed Oil | NSA | | |
|---|---|---|---|---|---|---|
| Desig- | Num- | Absorption | Absorption | Multi- | | Tint |
| nation | ber | Number | Number | point | STSA | Strength |
| N110 | 145 | 133 | 98 | 126 | 115 | 124 |
| N115 | 160 | 113 | 96 | 137 | 124 | 123 |
| N120 | 120 | 114 | 99 | 122 | 114 | 129 |
| N121 | 121 | 132 | 112 | 121 | 114 | 119 |
| N125 | 117 | 104 | 89 | 122 | 121 | 125 |
| N134 | 142 | 127 | 103 | 143 | 137 | 131 |
| N220 | 121 | 114 | 100 | 119 | 106 | 115 |
| N231 | 121 | 92 | 86 | 108 | 107 | 117 |
| N234 | 120 | 125 | 100 | 119 | 112 | 124 |
| N299 | 108 | 126 | 105 | 104 | 97 | 113 |
| N326 | 82 | 72 | 69 | 78 | 76 | 112 |
| N330 | 82 | 102 | 88 | 82 | 75 | 103 |
| N339 | 90 | 120 | 101 | 93 | 88 | 110 |
| N347 | 90 | 124 | 100 | 85 | 83 | 103 |
| N351 | 68 | 120 | 97 | 73 | 70 | 100 |
| N358 | 84 | 150 | 108 | 80 | 87 | 98 |
| N375 | 90 | 114 | 97 | 96 | 78 | 115 |
| N550 | 43 | 121 | 88 | 42 | 39 | |
| N630 | 36 | 78 | 62 | 32 | 32 | |
| N650 | 36 | 122 | 84 | 36 | 35 | |
| N660 | 36 | 90 | 75 | 35 | 34 | |
| N762 | 27 | 65 | 57 | 29 | 28 | |
| N772 | 30 | 65 | 58 | 32 | 30 | |
| N990 | | 38 | 37 | 9 | 8 | |
| N991 | | 35 | 37 | 8 | 8 | |

Conversely, increasing the particle size as measured by decreasing the Iodine Number will improve hysteresis, decrease rolling resistance, but have an adverse effect on abrasion resistance and tire wear.

To improve the tire rolling resistance, low hysteresis carbon blacks have been developed which have a broad aggregate size distribution with higher percentage of larger aggregates compared with standard ASTM carbon blacks. Widened aggregate size distribution will increase the average interaggregate spacing which reduces the filler-filler network strength which in turn improves the rolling resistance. Table III shows two natural rubber-based model compounds, one containing N234 and one containing a low hysteresis grade containing a wider aggregate size distribution. LH11. As an example, the compound data has been prepared for two compounds whose formulations are described in Table III.

TABLE III
Model Natural Rubber Compound Containing N234 and
Low Hysteresis carbon Black

| | | Compound Number | |
|---|---|---|---|
| | | 1 | 2 |
| | | Carbon Black Grade | |
| | | N234 | LH11 |
| Natural Rubber | TSR10 | 100.00 | 100.00 |
| Renacit 11 | | 0.15 | 0.15 |
| Carbon Black | | 50.00 | 50.00 |
| Paraffin Wax | | 1.00 | 1.00 |
| Microcrystalline wax | | 0.50 | 0.50 |
| Aromatic Oil | | 5.00 | 5.00 |
| 6PPD (antiozonant) | | 2.50 | 2.50 |
| TMQ (antioxidant) | | 1.00 | 1.00 |
| Zinc Oxide | | 4.00 | 4.00 |
| Stearic Acid | | 2.00 | 2.00 |
| TBBS | | 1.00 | 1.00 |
| Sulfur | | 1.00 | 1.00 |
| Retarder CTP | | 0.20 | 0.20 |
| Total PHR | | 168.35 | 168.35 |
| Iodine Absorption Number | g/kg | 119.2 | 117.0 |
| (IAN) | | | |
| COAN (CDBP) | ml/100 g | 99.5 | 110.0 |
| Nitrogen Surface Area (NSA) | m²/g | 116.5 | 116.9 |
| STSA | m²/g | 111.2 | 109.7 |
| Tint | % ITRB | 114.3 | 113.3 |

Table IV presents the rubber compound properties data. The results showed that compared to the control compound containing the carbon black grade N234, the low hysteresis carbon black had the same tensile strength and modulus, hardness, equivalent tear strength, but higher rebound at 60° C. and lower tangent delta at 60° C. both suggesting improved hysteresis and better tire rolling resistance. The Payne Effect is a further indication of a compound's contribution to lower tire rolling resistance. In this instance the Payne Effect is described as reduction of compound stiffness as defined by the drop in storage modulus, ΔG′, (kPa), obtained by conducting strain sweep. In this case, the Payne Effect dropped from 1239 kPa to 915 kPa which is indicative of improved filler-polymer interaction and is in turn, in agreement with the trend in tan delta and rebound results, and furthermore, the reduced Payne Effect is also consistent with improved abrasion resistance.

Though the improvement in compound hysteresis is attainable using carbon black grades with broader aggregate size distributions, other methods are also being researched. Examples of methods to improve performance have included research on further optimizing carbon black particle size and structure, optimizing the particle surface chemistry, and functionalizing the carbon black particle with coupling agents such as organo-silanes, amines, and carboxylic acids.

TABLE IV
Test Results

| | | Compound Number | |
|---|---|---|---|
| | | 1 | 2 |
| | | Carbon Black Grade | |
| | | N234 | LH11 |
| Tensile | MPa | 28.0 | 27.2 |
| Elongation, % | % | 625 | 590 |
| M 100% | MPa | 2.34 | 2.33 |
| M 300% | MPa | 10.42 | 10.54 |
| M400% | MPa | 15.98 | 16.34 |
| M 300/M100 | M 300/M100 | 4.5 | 4.5 |
| Hardness | Shore “A” | 63.00 | 62.00 |
| Tear Strength | Median, kNm⁻¹ | 146.4 | 153.1 |
| DIN Abrasion | mm³ | 180.6 | 166.8 |
| Rebound, % | 0° C. | 35.6 | 35.4 |
| | 60° C. | 55.2 | 56.8 |
| tan delta | 0° C. | 0.2945 | 0.3045 |
| tan delta | 60° C. | 0.2217 | 0.2096 |
| Payne Effect | Maximum G′_{0.1}, kPa | 1547 | 1315 |
| | Minimum G′₁₀, kPa | 308 | 320 |
| | ΔG′, kPa | 1239 | 995 |

### BRIEF DESCRIPTION OF THE DRAWINGS

The present disclosure may take a physical form in certain parts and an arrangement of parts, aspects of which will be described in detail in this specification and illustrated in the accompanying drawings which form a part hereof and wherein:

FIG. 1 shows disclosed amino acidic compounds which might serve as carbon black functionalization agents.

FIG. 2 shows a chart of the Payne effect for the N234 compound versus a treated N234 compound.

FIG. 3 shows a chart of the tear strength and tire tread chip/chuck/cut resistance from ASTM D624.

FIG. 4 shows a chart of the Payne Effect for compound 3, 4, N220 Carbon Black versus a treated N220 compound.

### DETAILED DESCRIPTION

The following detailed description is merely exemplary in nature and is not intended to limit the described aspects or the application and uses of the described aspects. As used herein, the words “exemplary” or “illustrative” mean “serving as an example, instance, or illustration.” Any implementation described herein as “exemplary” or “illustrative” is not necessarily to be construed as preferred or advantageous over other implementations. All the implementations described below are exemplary implementations provided to enable persons skilled in the art to make or use the aspects of the disclosure and are not intended to limit the scope of the disclosure, which is defined by the claims.

The United States Patent U.S. Pat. No. 11,753,549 B2 and US Patent Application Publication US2024/0002671 A1 describe the surface modification of low hysteresis carbon blacks with the chemical compounds containing at least one amine group and at least one thiol group and/or di- and/or polysulfidic linkage such as sulfur containing amino acidic compounds or their derivatives. Such a chemical modification will increase the chemical reactivity of the carbon black surface thus allowing greater polymer-filler reinforcement, and consequently lower compound hysteresis as represented by a decrease in the Payne Effect. The use of low hysteresis carbon blacks with broaden aggregate size distribution in the aforementioned patents was targeted to further decrease of filler-filler interactions. The chemical modification described in those inventions is also applicable to non-low hysteresis carbon blacks including the ASTM defined carbon blacks. Although the lowering of compound hysteresis is not great as the low hysteresis carbon blacks, the non-low hysteresis carbon blacks can still produce significant lowering of compound hysteresis with the similar chemical modification. Therefore, the development of chemically modified non-low hysteresis carbon blacks is greater importance in industrials applications such as tire tread compounds with low rolling resistance and high tread wear resistance.

In embodiments, the non-low hysteresis carbon black used according to the current invention is non-oxidized. Oxidized carbon blacks are a different species from regular/virgin carbon blacks (ASTM grade). Oxidized carbon blacks are prepared by post treatment of carbon blacks. However, in the present teaching, the surface modified carbon black is obtained by non-oxidized carbon black. Compared to the oxidized carbon blacks, non-oxidized carbon blacks contain fewer number of oxygens containing groups such as carboxylic groups on the surface. The United States Patent U.S. Pat. No. 11,753,549 B2 indicated the number of carboxylic groups present on N234 grade carbon black: 7.69 μmol/g (<50 μmol/g).

In embodiments, the non-low hysteresis carbon blacks used to surface modification of current invention can include ASTM defined carbon black, channel black, lamp black, gas black, furnace black, thermal black, acetylene black or Austin black. In some embodiments, the non-low hysteresis carbon blacks used to surface modification of current invention can in particular have a BET surface area ranging from about 10 m²/g to about 300 m²/g and specific surface area (STSA) ranging from about 10 m²/g to about 200 m²/g. In embodiments, the non-low hysteresis carbon blacks used according to the invention can have an oil absorption number (OAN) measured according to ASTM D2414-18 ranging from about 20 mL/100 g to about 250 mL/100 g and compressed oil absorption number (COAN) measured according to ASTM D3493-18 ranging from about 20 mL/100 g to about 150 mL/100 g.

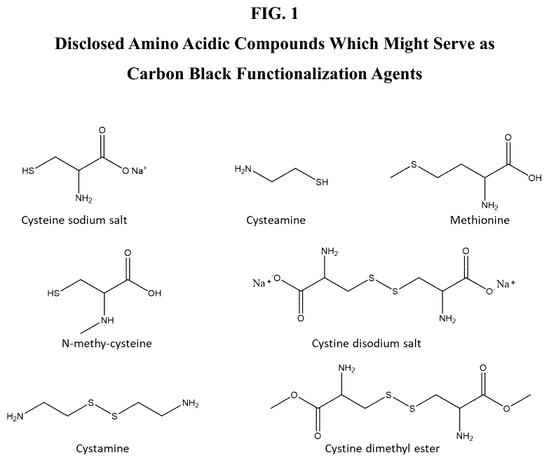

The current invention is the modification of non-low hysteresis carbon blacks including the ASTM defined carbon blacks with the chemical compounds containing at least one amine group and at least one thiol group and/or di- and/or polysulfidic linkage. In embodiments, the surface modifying agent comprises an amino acidic compound or its' derivative wherein any stereogenic centers present in the compound could be R and/or S configuration. For example, in embodiments, the amino acidic compound comprises a naturally occurring amino acid; a modified natural amino acid; a synthetic amino acid; a dimer thereof; a polymer thereof; a salt thereof; a derivative thereof, or a combination thereof. Nonlimiting examples of surface modifying agents suitable for use in the present disclosure include cysteine, cystine, homocysteine, homocystine, methionine, cysteamine, cystamine, cystine dimethyl ester, cystine disodium salt and a combination thereof. Some of the examples of surface modifying agents suitable for use in the present disclosure are illustrated in FIG. 1.

In embodiments, the surface modifying agent comprises an amino acidic compound or its' derivative having at least one amine group and one thiol group and/or di- and/or polysulfidic linkage, and/or an organic or inorganic compound containing at least one amine group, and at least one thiol group and/or di- and/or polysulfidic linkage. In embodiments, the amine group described here is not limited to a primary amine group which may be any type of amine (e.g., secondary amine or tertiary amine with or without a catalyst) suitable for linking to the carbon black surface. The surface modifying agent may comprise more than one amine or other functional groups. The surface modifying agent may be chemically linked to the surface of the carbon black (e.g., the surface of the non-low hysteresis carbon black) via single or multiple bonds. In embodiments, the surface modifying agent functions to form at least one bond to the surface of the carbon black (e.g., an amide bond).

In an embodiment of the methods of the present disclosure, the non-low hysteresis carbon black is treated with the surface modifying agent using any suitable methodology. In an embodiment, surface modified non-low hysteresis carbon black is prepared by treating the surface of the non-low hysteresis carbon black with about 0.1% (w/v) to about 50% (w/v), with about 0.1% (w/v) to 30% (w/v), preferably with about 1% (w/v) to about 20% (w/v) of surface modifying agent in a suitable solvent (e. g., water) followed by a heat treatment. In an embodiment, the mixing of carbon black with surface modifying agent containing solution can be carried out by a technique of pouring, spraying, injecting, dispersing or diffusing. The heat treatment of surface modifying agent mixed carbon black may be achieved at temperatures ranging from about 60° C., to about 450° C., alternatively from about 90° C. to about 350° C. or preferably from about 120° C. to about 300° C. for a time period of from about 0 to about 72 Hours, alternatively from about 0 to about 24 Hours, alternatively from about 0 to about 8 Hours, or preferably from about 0 to about 0.5 Hours. In an embodiment, the heat treatment step for thermochemical coupling may be carried out using a suitable heating source. Upon reaction, the resulting material is a surface modified non-low hysteresis carbon black (SMNLHCB). The SMNLHCB may then be preferably dried to remove any excess reaction solution and used without any further refining.

In an alternative embodiment, the SMNLHCB is refined using a suitable solvent (e.g., water) to remove weakly bound surface modifying agent. Specifically, the presence of loosely bound or physiosorbed surface modified agent on carbon black results in adverse effects on mechanical properties of the final rubber compound. Refining of the SMNLHCB as a slurry may be carried out in any suitable vessel without but preferably with agitation. In some embodiments, subsequent to refining of the SMNLHCM with the solvent, the solid carbon material and fluid may be separated, and the solid carbon material used with or without further refining.

In some embodiments, refining of the SMNLHCB black is carried out a plurality of times in cycles involving contacting of the surface SMNLHCB with a first amount of a solvent, removal of the fluid and refining the surface modified non-low hysteresis carbon black with a second amount of solvent. This may be carried out for any number of cycles so as to meet objectives, desired properties, and final product performance. In another aspect, there may be just 1 refining cycle, or alternatively the number of refining cycles may range from about 1 to about 10, alternatively from about 1 to about 6 or alternatively from about 1 to about 4. The resulting material is termed a refined surface modified non-low hysteresis carbon black.

In embodiments, the resultant refined or unrefined SMNLHCB comprises functionalities derived from the surface modifying agent bonded to the surface of the carbon black. In embodiments wherein the SMNLHCB is unrefined, the material additionally contains advantageous associated surface modifying agents or fragments thereof that are electrostatically (ionically) bonded, covalently bonded, Van der Waals forces bonded, hydrogen bonded, other non-covalently bonded with active surface moieties of the surface or alternatively not bonded to the surface of the low hysteresis carbon black and thus at least a portion of which are readily removable by refining the material. Non-limiting examples of types of bonding that may occur between the functionalities present in the surface modifying agent and the low hysteresis carbon black thus include Van der Waals interactions, covalent (including dative bonds) and/or ionic or other non-covalent interactions with active surface moieties of the surface. In one or more embodiments, the active surface moieties of the surface of refined or unrefined non-low hysteresis carbon black comprise oxygen, nitrogen, and/or sulfur and other elements found in materials used in carbon black manufacturing and rubber compounding. As a further example, surface modifying agents containing amine groups may bind to the carbon black surface by reacting with strong acidic groups present on the surface such as carboxylic groups. In one or more embodiments, carboxylic acid groups present in non-low hysteresis carbon black can be converted to acyl chloride or acid anhydrides prior to the treatment with a surface modifying agent. Compared to carboxylic acid, acyl chloride and acid anhydrides readily reacts with amine group/s in surface modifying agent.

In an embodiment, the surface modifying agent comprises from about 0.1 wt. % to about 50 wt. %, from about 0.1 wt. % to about 30 wt. %, from about 1 wt. % to about 16 wt. %, or preferably from about 3 wt. % to about 20 wt. % of the refined or unrefined SMNLHCB.

In embodiments, SMNLHCB product has a BET surface area ranging from about 10 m²/g to about 300 m²/g and specific surface area (STSA) ranging from about 10 m²/g to about 200 m²/g. In embodiments, SMNLHCB has an oil absorption number (OAN) measured according to ASTM D2414-18 ranging from about 20 mL/100 g to about 250 mL/100 g and compressed oil absorption number (COAN) measured according to ASTM D3493-18 ranging from about 20 mL/100 g to about 150 mL/100 g.

In embodiments, the thiol group(s) present in the surface modification agent may form a chemical bond with unsaturated bonds present in the polymer. The di/polysulfidic linkage in the surface modification agent can fracture during vulcanization and form a chemical bond with unsaturated polymer. In further aspects, the surface modification agent can further react with elemental sulfur to form additional di/poly sulfidic linkages between the filler and polymer.

### Polymer Composition

Also disclosed herein is a rubber composition comprising refined or unrefined SMNLHCB in a polymer. In an embodiment, the polymer is chosen from the group consisting of natural rubber and its various raw, reclaimed, or modified forms; various synthetic rubber polymers such as styrene butadiene rubber (SBR), polybutadiene rubber, halogenated butyl rubber, butyl rubber, polyisoprene rubber, and styrene/isoprene/butadiene terpolymer rubbers or any combinations therefore, depending upon the desired end use.

An embodiment of this invention is the non-low hysteresis carbon blacks including the ASTM defined carbon blacks which has been treated using a sulfur containing amino acidic compound or it's derivative, a non-limiting example of which is cystine disodium salt (FIG. 1). The production of such a treated carbon black is consequently suited to replace highly dispersible silica (HDS) and silane coupling agent in tire tread compounds as described in US Patent Application Publication US2024/0,002,671 A1.

### EXAMPLES

The descriptions and aspects described in the following examples demonstrate the advantages of treating carbon black with sulfur containing amino acidic compounds or their derivatives to all grades of commercially available non-oxidized furnace grade carbon black. The examples are given to illustrate the benefits and are thus not limited to the specific grades demonstrated.

### Example 1

To further improve or reduce the hysteresis of N234 carbon black, the refined surface modified N234 material was prepared as described in the United States Patent Application Publication US2024/0002671 A1 example 3. The carbon black was then mixed in a model natural rubber-based truck tire tread compound as in Table V. Table V shows two compounds numbered 3 and 4 as follows: Compound 3 with N234, Compound 4 with treated N234, i.e., N234-T. Treatment of the carbon black, N234, resulted in a drop in Iodine Number from nominally 119 to 82.

Though the Iodine number has dropped, the carbon black particle size has remained unchanged, the drop being due to the treatment affecting iodine absorption. Similarly for nitrogen surface area. Structure as measured by oil absorption number or OAN has remained unchanged with both data being essentially equivalent.

Table VI contains the compound processing properties. Mooney peak obtained from the Mooney viscosity test is a tentative indicator for bound rubber which showed an increase suggesting greater reinforcement. However, the increase in Mooney viscosity was small and within a range acceptable for extrusion or other processing operations. Vulcanization kinetics are also shown in Table VII. The state of cure (MH-ML) increased suggesting better reinforcement and crosslink density with little effect on rate of vulcanization.

Most significant, there is a large decrease in the Payne Effect indicating increased polymer-filler interaction which is required for improvement in hysteresis, and in tread compounds is better or lower rolling resistance. Compared to Compound 2 (Table IV) where the ΔG′ of 995 kPa showed a reduction of 244 kPa compared to the reference compound, Compound 4 had a storage modulus of 358 kPa and showed a reduction of 482 kPa versus the reference. Carbon black functionalization is thus more effective at improving the Payne Effect compared to use of broader carbon black particle size distributions.

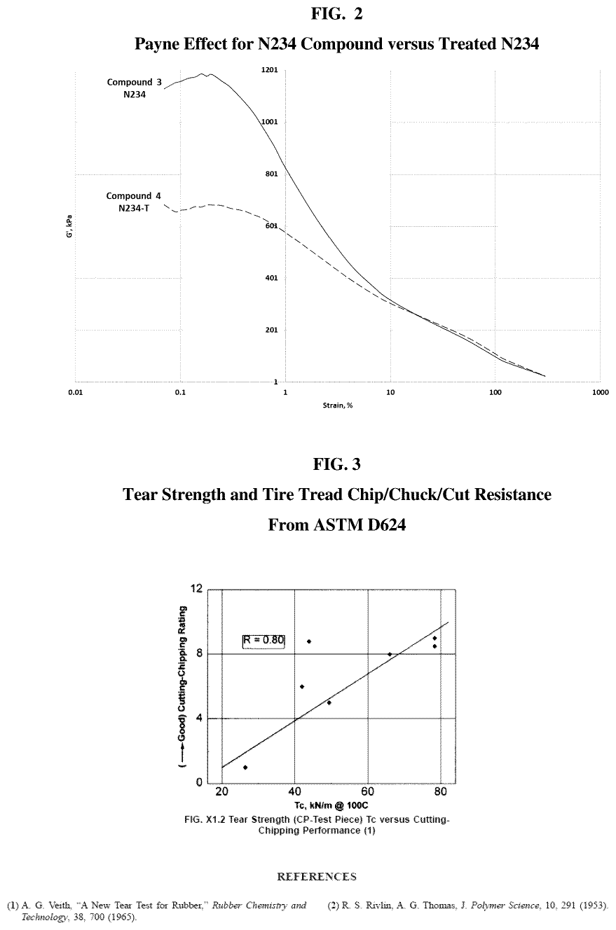

The drop in the ΔG′ or the Payne Effect is illustrated in FIG. 2. This is a dynamic strain sweep readily conducted on a Rubber Processability Analyzer (RPA) at 70° C., and nominal frequency of 1 Hz. The reduction due to treatment of N234 in this case is evident.

TABLE V
Treatment of N234

| | | Compound Number | |
|---|---|---|---|
| | | 3 | 4 |
| | | Carbon Black Grade | |
| | | N234 | N234-T |
| | | Derivative | |
| | | | T (Note 1) |
| Natural Rubber | TSR10 | 100.00 | 100.00 |
| Peptizer | | 0.15 | 0.15 |
| Carbon Black | | 46.00 | 46.00 |
| Paraffin Wax | | 1.00 | 1.00 |
| Microcrystalline wax | | 0.50 | 0.50 |
| Aromatic Oil | | 5.00 | 5.00 |
| 6PPD (antiozonant) | | 2.50 | 2.50 |
| TMQ (antioxidant) | | 1.00 | 1.00 |
| Zinc Oxide | | 4.00 | 4.00 |
| Stearic Acid | | 2.00 | 2.00 |
| TBBS (accelerator) | | 1.00 | 1.00 |
| Sulfur | | 1.00 | 1.00 |
| Retarder CTP | | 0.20 | 0.20 |
| Total PHR | | 164.35 | 164.35 |
| Iodine Number | g/kg | 119.2 | 82.4 |
| OAN (DBP) | ml/100 g | 127.4 | 123.1 |
| COAN | ml/100 g | 99.5 | 100.1 |
| Nitrogen Surface Area | m²/gm | 116.5 | 103.4 |
| STSA | m²/gm | 111.2 | 96.00 |
| Tint | % ITRB | 114.3 | 82.6 |

Note:
1. Treated
2. Rubber chemicals are typical commercial grades used for tire compounds

Table VII shows the mechanical properties of Compounds 3 and 4. Treatment of N234 has led to improvements in rebound and tan delta at 60° C., indicating improvement in rolling resistance., higher tear strength, but equivalent abrasion resistance, tensile strength and modulus.

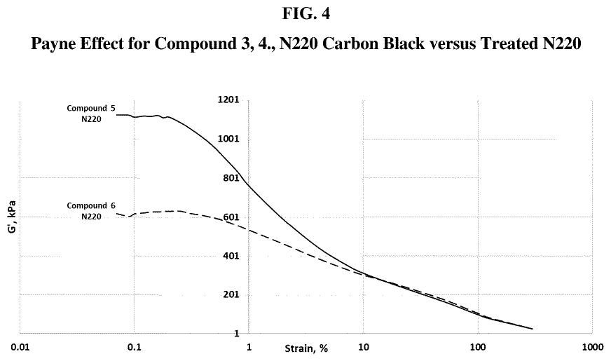

Increase in compound tear strength demonstrated in this example, according to the test method for Tear Strength of Conventional Vulcanized Rubber and Thermoplastic Elastomers outlined in the standard ASTM D624, represents improved resistance to tire cutting and chipping. The illustration in support of this observation has been reproduced from ASTM D624 (FIG. 4).

TABLE VI
Model Compound with N234 AND Treated N234
Processing Properties
[See Note for description]

| | Compound Number | |
|---|---|---|
| | 3 | 4 |
| | Carbon Black Grade | |
| | N234 | N234-T |
| | Derivative | |
| | | T |
| Mooney Viscosity | | |
| Peak Viscosity. (MU) | 66.52 | 91.36 |
| ML1 + 4 (MU) | 48.11 | 56.82 |
| Mooney Scorch | | |
| Viscosity (MU) | 35.40 | 40.15 |
| t5 (minutes) | 34.87 | 19.97 |
| t10 (minutes | 36.11 | 21.47 |
| t35 (minutes) | 37.95 | 23.81 |
| RPA Rheometer | | |
| ML, in-lb | 1.61 | 2.04 |
| MH, in-lb | 11.40 | 12.55 |
| MH-ML, in-lb | 9.79 | 10.51 |
| T_{C}10, min | 2.78 | 1.94 |
| T_{C}50, min | 4.20 | 3.17 |
| T_{C}90, min | 6.21 | 5.24 |
| CRI (100/(t90 − t10)) | 29.15 | 30.30 |
| Payne Effect | | |
| Maximum G′_{0.1}, kPa | 1156 | 661 |
| Minimum G′₁₀, kPa | 316 | 303 |
| ΔG′, kPa | 840 | 358 |

Notes:
MU. Mooney Units
ML. Minimum torque
MH. Maximum torque
MH-ML. Delta torque (cure state)
G′. Storage modulus

TABLE VII
Mechanical Properties of N234 versus Treated N234

| | | Compound Number | |
|---|---|---|---|
| | | 3 | 4 |
| | | Carbon Black Grade | |
| | | N234 | N234-T |
| | | Derivative | |
| | | | T |
| Tensile | MPa | 26.72 | 27.22 |
| Elongation, % | % | 621.91 | 624.71 |
| M 100% | MPa | 2.16 | 2.34 |
| M 200% | MPa | 4.84 | 4.91 |
| M 300% | MPa | 9.21 | 8.98 |
| M 300/M100 | M 300/M100 | 4.26 | 3.84 |
| Hardness | Shore “A” | 59.00 | 62.00 |
| Tear Strength kNm | | 135.50 | 153.64 |
| Din Abrasion | mm³ (volume loss) | 181.90 | 191.20 |
| Rebound, % | 0° C. | 37.80 | 41.60 |
| [Zwick] | 20° C. | 48.60 | 54.00 |
| | 60° C. | 56.90 | 63.40 |
| tan delta | 0° C. | 0.2976 | 0.2815 |
| | 60° C. | 0.2143 | 0.1601 |

### Example 2

In this instance the four commercially available grades of carbon black were treated with a cystine disodium salt to prepare refined surface modified materials as described in US patent application US2024/0,002,671 A1 example 3. The grades of carbon black considered are ASTM grades N220, N330, N339, and low hysteresis HAF grade LH30. Table VIII shows eight compounds numbered 5 to 12 as follows: Compound 5 with N220, Compound 6 with treated N220, i.e., N220-T, similarly for N330, N339 and LH30 respectively. Table IX further shows the specific properties of the carbon black used in each of the eight compounds.

Treatment of the carbon black grades led to an apparent drop in Iodine Number suggesting a shift in carbon black particle size. This is attributed to an anomaly where the treatment agent is affecting iodine absorption. In all cases however, treatment has led to a significant increase in the low hysteresis effect as determined from the difference in Nitrogen Surface Area (NSA) and Iodine Absorption Number (IAN).

TableI X shows the compound processing information and specifically the Mooney viscosity, Mooney scorch, vulcanization kinetics using the RPA, and Payne Effect data. Briefly, the Mooney Peak obtained from the Mooney viscosity test, as a tentative indicator of bound rubber, increased in every case upon treatment of the carbon black, but viscosity (ML1+4) decreased suggesting better processing. Cure state or MH-ML increased upon treatment and t10 and t90 decreased slightly though vulcanization rate was not significantly affected. Most important, large decreases in the Payne Effect were observed, much greater than that achieved using low hysteresis carbon blacks (Table IV). Of the four carbon black grades considered in this instance, N220 showed the largest improvement, this being attributed to the higher initial Iodine number (FIG. 4).

TABLE VIII
Treatment of ASTM Carbon Black Grades N220, N330, N339, and Low Hysteresis Grade LH30

| | Compound Number | | | | | | | |
|---|---|---|---|---|---|---|---|---|
| | 5 | 6 | 7 | 8 | 9 | 10 | 11 | 12 |
| Carbon Black Grade | N220 | N220-T | N330 | N330-T | N339 | N339-T | LH30 | LH30-T |
| Treated (T) | | T | | T | | T | | T |
| Natural Rubber | 100.00 | 100.00 | 100.00 | 100.00 | 100.00 | 100.00 | 100.00 | 100.00 |
| Peptizer | 0.15 | 0.15 | 0.15 | 0.15 | 0.15 | 0.15 | 0.15 | 0.15 |
| Carbon Black | 50.00 | 50.00 | 50.00 | 50.00 | 50.00 | 50.00 | 50.00 | 50.00 |
| Paraffin Wax | 1.00 | 1.00 | 1.00 | 1.00 | 1.00 | 1.00 | 1.00 | 1.00 |
| Microcrystalline wax | 0.50 | 0.50 | 0.50 | 0.50 | 0.50 | 0.50 | 0.50 | 0.50 |
| Aromatic Oil | 5.00 | 5.00 | 5.00 | 5.00 | 5.00 | 5.00 | 5.00 | 5.00 |
| 6PPD | 2.50 | 2.50 | 2.50 | 2.50 | 2.50 | 2.50 | 2.50 | 2.50 |
| TMQ | 1.00 | 1.00 | 1.00 | 1.00 | 1.00 | 1.00 | 1.00 | 1.00 |
| Zinc Oxide | 4.00 | 4.00 | 4.00 | 4.00 | 4.00 | 4.00 | 4.00 | 4.00 |
| Stearic Acid | 2.00 | 2.00 | 2.00 | 2.00 | 2.00 | 2.00 | 2.00 | 2.00 |
| TBBS | 1.00 | 1.00 | 1.00 | 1.00 | 1.00 | 1.00 | 1.00 | 1.00 |
| Sulfur | 1.00 | 1.00 | 1.00 | 1.00 | 1.00 | 1.00 | 1.00 | 1.00 |
| Retarder CTP | 0.20 | 0.20 | 0.20 | 0.20 | 0.20 | 0.20 | 0.20 | 0.20 |
| Total PHR | 168.35 | 168.35 | 168.35 | 168.35 | 168.35 | 168.35 | 168.35 | 168.35 |
| Carbon Black Properties | | | | | | | | |
| Iodine Number | 118.4 | 82.9 | 84.8 | 61.1 | 88.9 | 66.1 | 77.6 | 61.4 |
| COAN (CDBP) | 97.6 | 100.2 | 89.7 | 91.3 | 97.3 | 97.7 | 107.2 | 108.1 |
| Nitrogen Surface Area | 109.9 | 95.6 | 78.2 | 71.6 | 93.1 | 86.1 | 92.0 | 86.2 |
| STSA | 103.8 | 91.7 | 75.3 | 68.7 | 89.1 | 81.7 | 84.8 | 77.4 |
| Tint | 112.1 | 87.1 | 104.9 | 89.9 | 109.8 | 86.3 | 103.3 | 83.6 |

Furthermore, the reductions in the Payne Effect were much greater than that achieved by broadening the carbon black particle size; this observation being noted for all ASTM grades of carbon black studied in this instance. By inference the same would be noted for all grades of carbon black defined in Table II of this disclosure.

The mechanical properties for Compounds 5 to 12 are in Table X. In all four carbon black grades, N220, N330, N339 and LH30, treatment had no effect on tensile strength or elongation at break. With the exception of N330, tear strength was essentially equivalent or improved. DIN abrasion as measured by volume loss was improved for all four cases. This would suggest that under some wear conditions, a tire tread wear performance improvement could be expected. Tread wear occurs by one of two fundamental mechanisms, a tensile failure and tearing process which would occur under fast wear, and a thermo-oxidative degradation which would occur under slow wear. The DIN abrasion test would be more representative of fast wear conditions. Regardless of the process of wear, for both bases it is accepted that the procedure offers insight regarding the abrasion resistance of model compounds.

Similarly, compound rebound was improved by a large percentage, this inferring the use of treated carbon blacks will have a significant effect on tread compound hysteresis and in turn, tire rolling resistance.

TABLE IX
Treatment of ASTM Carbon Black Grades N220, N330, N339, and Low Hysteresis Grade LH30
Compound Processing

| | Compound Number | | | | | | | |
|---|---|---|---|---|---|---|---|---|
| | 5 | 6 | 7 | 8 | 9 | 10 | 11 | 12 |
| Carbon Black Grade | N220 | N220-T | N330 | N330-T | N339 | N339-T | LH30 | LH30-T |
| Treated (T) | | T | | T | | T | | T |
| Mooney Viscosity | | | | | | | | |
| Peak Viscosity, | 74.66 | 84.04 | 65.18 | 70.26 | 67.11 | 84.75 | 77.71 | 95.55 |
| MU | | | | | | | | |
| ML1 + 4 (MU) | 47.01 | 50.61 | 43.00 | 42.72 | 43.67 | 48.47 | 47.98 | 50.68 |
| Mooney Scorch | | | | | | | | |
| Viscosity MU | 35.25 | 36.21 | 32.67 | 32.08 | 32.19 | 35.76 | 35.02 | 37.57 |
| t5 (minutes) | 39.11 | 19.15 | 35.16 | 18.40 | 33.56 | 16.16 | 37.25 | 16.02 |
| t10 (minutes | 40.91 | 20.83 | 36.85 | 20.10 | 34.97 | 17.77 | 38.88 | 17.72 |
| t35 (minutes) | 43.45 | 23.49 | 39.20 | 22.84 | 36.92 | 20.51 | 41.19 | 20.72 |
| Payne Effect | | | | | | | | |
| Maximum G′_{0.1}, kPa | 1113.75 | 617.67 | 761.52 | 452.96 | 679.61 | 492.55 | 761.45 | 471.48 |
| Minimum G′₁₀, kPa | 311.07 | 302.37 | 273.48 | 262.29 | 287.24 | 277.33 | 302.90 | 279.13 |
| ΔG′, kPa | 802.68 | 315.30 | 488.04 | 190.67 | 392.38 | 215.22 | 458.55 | 192.35 |
| RPA Rheometer | | | | | | | | |
| ML, in-lb | 1.75 | 1.78 | 1.43 | 1.33 | 1.43 | 1.52 | 1.53 | 1.59 |
| MH, in-1b | 11.40 | 12.97 | 10.30 | 10.63 | 9.85 | 11.77 | 10.84 | 11.92 |
| MH − ML, in-lb | 9.65 | 11.19 | 8.87 | 9.30 | 8.41 | 10.25 | 9.32 | 10.33 |
| Tc10, min | 3.20 | 2.00 | 2.99 | 2.01 | 2.61 | 1.81 | 3.02 | 1.83 |
| Tc50, min | 4.75 | 3.25 | 4.34 | 3.30 | 3.90 | 3.03 | 4.33 | 3.08 |
| Tc90, min | 6.90 | 5.25 | 6.48 | 5.22 | 6.05 | 4.96 | 6.51 | 5.08 |
| Cure Rate Index | 27.03 | 30.77 | 28.65 | 31.15 | 29.07 | 31.75 | 28.65 | 30.77 |
| (CRI) | | | | | | | | |

Notes:
CRI (100/(t90 − t10)), sec⁻¹

As noted, the surface modification of all ASTM grades described in Table II can be conducted. Table XI shows a typical example of what carbon black grades are used in different tire components. Modification of all of the general grades presented can be conducted thus having the effect of reducing each compound's hysteresis, and in turn each compound's contribution to whole tire hysteresis. Thus, further reductions in tire rolling resistance are feasible beyond that obtained by just the tread compound alone.

TABLE X
Treatment of ASTM Carbon Black Grades N220, N330, N339, and Low Hysteresis Grade LH30
Mechanical Properties

| | Compound Number | | | | | | | |
|---|---|---|---|---|---|---|---|---|
| | 5 | 6 | 7 | 8 | 9 | 10 | 11 | 12 |
| Carbon Black Grade | N220 | N220-T | N330 | N330-T | N339 | N339-T | LH30 | LH30-T |
| Treated (T) | | T | | T | | T | | T |
| Tensile Str. (MPa) | 26.69 | 26.99 | 27.55 | 26.91 | 26.27 | 27.42 | 24.54 | 25.41 |
| Elongation, % | 616.71 | 598.35 | 611.97 | 613.65 | 608.50 | 598.80 | 543.48 | 554.95 |
| M 100% (MPa) | 2.40 | 2.60 | 2.53 | 2.45 | 2.08 | 2.54 | 2.40 | 2.53 |
| M 200% (MPa) | 5.24 | 5.37 | 5.79 | 5.28 | 4.96 | 5.69 | 5.95 | 5.60 |
| M 300% (MPa) | 9.73 | 9.69 | 10.61 | 9.59 | 9.68 | 10.53 | 11.14 | 10.54 |
| M 300/M100 | 4.05 | 3.73 | 4.20 | 3.92 | 4.65 | 4.14 | 4.64 | 4.17 |
| Hardness Shore A | 61.00 | 60.50 | 60.00 | 56.00 | 61.00 | 59.50 | 61.50 | 60.00 |
| Tear Strength | 146.82 | 136.39 | 132.92 | 99.53 | 146.46 | 152.19 | 133.84 | 136.29 |
| DIN Abrasion | 191.80 | 154.10 | 203.70 | 195.90 | 206.30 | 155.80 | 181.90 | 152.00 |
| Rebound, % | 36.00 | 45.60 | 37.60 | 41.60 | 39.00 | 41.70 | 38.00 | 45.80 |
| [Zwick] | 46.90 | 60.90 | 51.50 | 57.40 | 50.20 | 58.20 | 51.80 | 59.90 |
| | 56.40 | 70.40 | 60.50 | 67.50 | 57.30 | 67.80 | 61.00 | 69.60 |
| tan delta | 0.3049 | 0.2871 | 0.2937 | 0.2867 | 0.2904 | 0.2675 | 0.2940 | 0.2847 |
| | 0.2530 | 0.2079 | 0.2382 | 0.2032 | 0.2336 | 0.1997 | 0.2375 | 0.2029 |
| | 0.2132 | 0.1525 | 0.1996 | 0.1506 | 0.1953 | 0.1443 | 0.1902 | 0.1429 |

TABLE XI
Simple Examples of Carbon Blacks Used in Different
Tire Components

| Compound | Polymers | Carbon Black |
|---|---|---|
| Tread | NR, ESBR, | N10 series, N220 |
| | SSBR, BR | Series |
| Cushion | NR | N330 series |
| Shoulder Wedge | NR | N550 |
| Sidewall | NR, BR | N330, N550 |
| Belts, Breakers | NR | N326 |
| Fabric Ply | NR | N326 |
| Fabric Ply | NR | N326 |
| Gum Strips | NR | N326 |
| Bead Filler | NR | N550 |
| Barrier/ | NR | N326, N660 |
| Squeegee | | |
| Innerliner | HIIR | N660 |

### ADDITIONAL DISCLOSURE

The following are non-limiting, specific embodiments of the present teaching:

A first embodiment comprises: A surface modified non-low hysteresis carbon black (SMNLHCB) product, comprising: a non-low hysteresis carbon black having a surface that has been modified to have a surface modifier attached thereto, wherein the surface modifier comprises at least one amine group and at least one thiol group and/or di -and/or polysulfidic linkage.

A second embodiment can include SMNLHCB product of the first embodiment, wherein the non-low hysteresis carbon black used in surface modification comprises ASTM defined carbon black.

A third embodiment can include SMNLHCB product of the first embodiment, wherein the non-low hysteresis carbon black used in surface modification comprises channel black, lamp black, gas black, furnace black, thermal black, acetylene black or Austin black.

A fourth embodiment can include SMNLHCB product of the first embodiment, wherein the non-low hysteresis carbon black used in surface modification is non-oxidized.

A fifth embodiment can include SMNLHCB product of the first embodiment, wherein the surface modifier comprises an amino acidic compound or its derivative.

A sixth embodiment can include SMNLHCB product of the fifth embodiment, wherein the amino acidic compound comprises a naturally occurring amino acid, a modified natural amino acid, a synthetic amino acid, a dimer thereof, a polymer thereof, a salt thereof, a derivative thereof, or a combination thereof.

A Seventh embodiment can include SMNLHCB product of the fifth and sixth embodiments, wherein the amino acidic compound or its derivative comprises cysteine, cystine, homocysteine, homocystine, methionine, cysteamine, cystamine, cystine dimethyl ester, cystine disodium salt and a combination thereof.

An eighth embodiment can include SMNLHCB product of any one of the prior embodiments, wherein the surface modifier comprises an amino acidic compound or its derivative having at least one amine group and at least one thiol group and/or di- and/or polysulfidic linkage, and/or an organic or inorganic compound containing at least one amine group, and at least one thiol group and/or di- and/or polysulfidic linkage.

A nineth embodiment can include SMNLHCB product of any one of the prior embodiments, wherein the amine group contained in the surface modifier is any type of amine suitable for linking to the carbon black surface.

A tenth embodiment can include SMNLHCB product of the nineth embodiment, wherein the amine group contained in the surface modifier is a primary amine, a secondary amine, or a tertiary amine with or without a catalyst for linking to the carbon black surface.

An eleventh embodiment can include SMNLHCB product of any one of the prior embodiments, wherein surface modifier is linked to the surface via single or multiple bonds.

A twelfth embodiment can include SMNLHCB product of any one of the prior embodiments, wherein the surface modifier is linked to the carbon black surface by an amide or other bond formation, chemisorption, and/or physisorption.

A thirteenth embodiment can include SMNLHCB product of any one of the prior embodiments, wherein the surface modifier is linked to the carbon black surface by at least one of, van der Waals interactions, ionic and/or covalent or other non-covalent interactions with active surface moieties of the surface.

A fourteenth embodiment can include SMNLHCB product of the thirteenth embodiment, wherein said active surface moieties comprise oxygen, nitrogen, and/or sulfur on the surface.

A fifteenth embodiment can include SMNLHCB product of any one of the prior embodiments, wherein the surface modifier comprises from about 0.1 wt. % to about 50 wt. % of the surface modified carbon black (e.g., of the SMNLHCB).

A sixteenth embodiment can include SMNLHCB product of any one of the prior embodiments, wherein SMNLHCB has a BET surface area ranging from about 10 m²/g to about 300 m²/g.

A seventeenth embodiment can include SMNLHCB product of any one of the prior embodiments, wherein SMNLHCB has a specific surface area (STSA) ranging from about 10 m²/g to about 200 m²/g.

An eighteenth embodiment can include SMNLHCB product of any one of the prior embodiments, wherein SMNLHCB has an oil absorption number (OAN) measured according to ASTM D2414-18 ranging from about 20 mL/100 g to about 250 mL/100 g.

A nineteenth embodiment can include SMNLHCB product of any one of the prior embodiments, wherein SMNLHCB has a compressed oil absorption number (COAN) measured according to ASTM D3493-18 ranging from about 20 mL/100 g to about 150 mL/100 g.

A twentieth embodiment can include SMNLHCB product of any one of the prior embodiments, wherein SMNLHCB is refined.

While aspects of the present teaching have been shown and described, modifications thereof can be made by one skilled in the art without departing from the spirit and teachings of this disclosure. The aspects of the present teaching described herein are exemplary only and are not intended to be limiting. Many variations and modifications of the aspects disclosed herein are possible and are within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R1, and an upper limit, Ru, is disclosed, any number falling within the range is specifically disclosed. In particular, the following numbers within the range are specifically disclosed: R=R1+k*(Ru-R1), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an aspect of the present teaching. Thus, the claims are a further description and are an addition to the aspects of the present teaching. The discussion of a reference herein is not an admission that it is prior art, especially any reference that may have a publication date after the priority date of this application. The disclosures of all patents, patent applications, and publications cited herein are hereby incorporated by reference, to the extent that they provide exemplary, procedural, or other details supplementary to those set forth herein.

Non-limiting aspects have been described, hereinabove. It will be apparent to those skilled in the art that the above methods and apparatuses may incorporate changes and modifications without departing from the general scope of the present subject matter. It is intended to include all such modifications and alterations in so far as they come within the scope of the appended claims or the equivalents thereof.

What is claimed is:

1. A surface modified non-low hysteresis carbon black (SMNLHCB) product, comprising: a non-low hysteresis carbon black having a surface that has been modified to have a surface modifier attached thereto, wherein the surface modifier comprises at least one amine group and at least one thiol group and/or di- and/or polysulfidic linkage, and combination thereof.

2. The SMNLHCB product of claim 1, wherein the non-low hysteresis carbon black is ASTM defined carbon black.

3. The SMNLHCB product of claim 1, wherein the non-low hysteresis carbon black used in surface modification is chosen from the group consisting of channel black, lamp black, gas black, furnace black, thermal black, acetylene black, Austin black, and combinations thereof.

4. The SMNLHCB product of claim 1, wherein the surface modifier comprises an amino acidic compound or its derivative.

5. The SMNLHCB product of claim 4, wherein the amino acidic compound is chosen from the group consisting of a naturally occurring amino acid, a modified natural amino acid, a synthetic amino acid, a dimer thereof, a polymer thereof, a salt thereof, a derivative thereof, or a combination thereof.

6. The SMNLHCB product of claim 5, wherein the amino acidic compound or its derivative is chosen from the group consisting of cysteine, cystine, homocysteine, homocystine, methionine, cysteamine, cystamine, cystine dimethyl ester, cystine disodium salt, and combinations thereof.

7. The SMNLHCB product of claim 1, wherein the surface modifier comprises an amino acidic compound or its derivative having at least one amine group and at least one thiol group and/or di- and/or polysulfidic linkage, and/or an organic or inorganic compound containing at least one amine group, and at least one thiol group and/or di- and/or polysulfidic linkage.

8. The SMNLHCB product of claim 1, wherein the amine group contained in the surface modifier is an amine suitable for linking to the carbon black surface.

9. The SMNLHCB product of claim 8, wherein the amine group is chosen from the group consisting of a primary amine, a secondary amine, and a tertiary amine, with or without a catalyst for linking to the carbon black surface.

10. The SMNLHCB product of claim 1, wherein surface modifier is linked to the surface via single or multiple bonds.

11. The SMNLHCB product of claim 1, wherein the surface modifier is linked to the carbon black surface by an amide, a bond formation, chemisorption, and/or physisorption.

12. The SMNLHCB product of claim 1, wherein the surface modifier is linked to the carbon black surface by at least one of the group consisting of van der Waals interactions, ionic interactions, covalent interactions, and non-covalent interactions with active surface moieties of the surface.

13. The SMNLHCB product of claim 12, wherein the active surface moieties comprise oxygen, nitrogen, and/or sulfur on the surface.

14. The SMNLHCB product of claim 1, wherein the surface modifier comprises from about 0.1 wt. % to about 50 wt. % of the surface modified carbon black.

15. The SMNLHCB product of claim 1, wherein SMNLHCB has a BET surface area ranging from about 10 m²/g to about 300 m²/g.

16. The SMNLHCB product of claim 1, wherein the SMNLHCB has an oil absorption number (OAN) measured according to ASTM D2414-18 ranging from about 20 mL/100 g to about 250 mL/100 g.

17. The SMNLHCB product of claim 1, wherein SMNLHCB is refined.
